(19) United States
(12) Patent Application Publication
(10) Pub. No.: US 2010/0122828 A1
(43) Pub. Date: May 20, 2010

(54) slide-on groove and flange faceplate- tieplate cover for an electrical outlet.

(76) Inventor: Christopher Adam McLeod, Toronto (CA)

Correspondence Address: CHRISTOPHER ADAM MCLEOD, 44 WANLESS AVENUE, TORONTO, ON, M4N 1V6, CA

(21) Appl. No.: 12/272,770

(22) Filed: Nov. 17, 2008

(51) Int. Cl. H02G 3/14

(52) U.S. Cl. 174/66

(57) ABSTRACT

An assembly to hide the visual distraction of the electrical outlet consists of a faceplate box with an internal groove to the rear and an open bottom, allowing for sliding over a tieplate tied to a mounted electrical box. This tieplate bears a mating flange to the top and sides that is offset from rear of the tieplate to allow for sliding on of the faceplate. This faceplate can be manipulated whether or not flat-headed cords are plugged in. The faceplate is then free to bear a variety of finishes, including in-mould decorating, conventional plating, mirror finish, texture, and three-dimensional ornament.

### CROSS-REFERENCE TO RELATED APPLICATIONS

There are no cross references to other applications in this Patent Application.

### STATEMENT REGARDING FEDERALLY SPONSORED RESEARCH OR DEVELOPMENT

No federally sponsored research and development funds nor involvement led to this Patent Application.

### REFERENCE TO A SEQUENCE LISTING

No reference is made to a sequence listing in this Patent Application.

### AUTHOR AND INVENTOR

Christopher Adam McLeod is the Sole Inventor of this Utility and Author of this Application.

### BACKGROUND OF THE INVENTION

Electrical outlets are by design unsightly and unsafe.

Unsightliness arises from the interruption of smooth continuous decorating surfaces with a box with electrical receptacle holes and screw heads.

Unsafeness arises not only from the opportunity to insert little fingers and forks into these same holes, but by the very fact that leaving dust to collect in the electric prong holes is dangerous, and cleaning those holes is also dangerous.

This application describes a new faceplate-tieplate assembly that allows for a slip-on covering of the electrical outlet holes to cover flat head electrical cords. For reference, a tieplate here refers to the cover over the electrical box that is screwed in, and the faceplate refers to the cover over this.

There is a diversity of methods to cover an electrical outlet. Many of these involved hinged doors, e.g. Chrones (U.S. Pat. No. 4,070,078 Jan. 24, 1978), others focus on the covering the plug itself (no less unsightly), e.g. Pinkerton (U.S. Pat. No. 4,691,974 Sep. 8, 1987). In contrast, the number of patents employing the concept of a slide-on groove and mating flange are limited. Two illustrative examples are In (U.S. Pat. No. 7,094,969 Aug. 22, 2006) which does employ a groove and mating flange; however, only to close off the electrical outlet when it is not in use. Further, the cover slides up and needs to be locked up by fasteners. More interesting is Mcllvenna (U.S. Pat. No. 6,669,492 Dec. 30, 2003), which uses a groove and mating flange to position a cover over inserted plugs. The Mcllvenna design, however, suffers from drawbacks:
1) The box is bulky and designed to work with conventional plugs.
2) The groove is on the tieplate and the mating flange on the faceplate, again unsightly.
3) The cover clicks into place. For safety reasons quick removal of a plug can be critical and hand manipulation may not be an option.
4) The sliding cover uses latches within the groove to stop the cover when slide down and over the tieplate. This leaves an upper discontinuous surface that both allows for dust collection as well as simply being, again, unsightly.
5) Latches are moving parts and will eventually break.
6) Latches in a groove are difficult to form in injection moulding, preventing a single draw to form the faceplate.
7) A new user of the cover, not knowing where to press on the cover to make it move, nor which direction it should be removed, is likely to break the unit. This situation could be alleviated by labels printed on the outside of the cover, but that would be even more unsightly.

The utility described in this application has been developed to supply an aesthetically appealing way of covering the tieplate. It consists of a tieplate screwed to the electrical box as with conventional electrical tieplates (covers), excepting that the perimeter of the plate bears a mating flange that is thinner than the tieplate and offset from the plane of the rear of the tieplate. This enables a covering faceplate with a matching, internal groove in the rear to be slipped over and down on that tieplate until the upper part of the groove rests on the upper side of the tieplate flange. This cover must have some depth and an open bottom to allow this sliding. The depth is that depth sufficient to cover flat headed plugs that have been plugged into the electrical outlet. Flat headed plugs are those that have a 90 degree angle built into the head of the plug to enable the cord to drop down vertically. This means:
1) The covering assembly is slimline and minimizes aesthetic interruption.
2) The groove being internal to the faceplate and covering the tieplate entirely shows no break lines or junctures, again not interrupting appearance and optimally allowing for filleting or other minimization of sharp corners on the faceplate to further diminish presence.
3) The faceplate sits in place without a fastening device requiring fingers to remove it. This benefits emergency users, disabled users and other users who need to remove the cap in a hurry.
4) Since the upper surface of the faceplate lies on top of the tieplate, there is no break line nor juncture to interrupt decor or gather dust.
5) The entire assembly consists of one slide-on groove and mating flange, minimizing moving parts with the effect of greatly improving life of the assembly.
6) The simple groove and mating flange requires just a single draw to inject mould the faceplate.
7) No training is necessary to remove this cover, nor labels.

For these reasons, the Invention in this Application is significantly different from Prior Art, and is a boon the interior director looking for a way to diminish the necessary but unsightly visual interruption formed by the plug and receptacle.

### BRIEF SUMMARY OF THE INVENTION

The utility described in this application has been developed to supply an aesthetically appealing way of covering the faceplate. It consists of a tieplate screwed to the electrical box as with conventional electrical tieplates (covers), excepting that the perimeter of the plate bears a mating flange that is thinner than the tieplate and offset from the plane of the rear of the tieplate. This enables a covering faceplate with a matching, internal groove in the rear to be slipped over and down on that tieplate until the upper part of the groove rests on the upper side of the tieplate flange. This cover must have some depth and an open bottom to allow this sliding. The depth is that depth sufficient to cover flat headed plugs that have been plugged into the electrical outlet. Flat headed plugs are those that have a 90 degree angle built into the head of the plug to enable the cord to drop down vertically. This means:
1) The covering assembly is slimline and minimizes aesthetic interruption.
2) The groove being internal to the faceplate and covering the tieplate entirely shows no break lines or junctures, again not interrupting appearance and optimally allowing for filleting or other minimization of sharp corners on the faceplate to further diminish presence.
3) The faceplate sits in place without a fastening device requiring fingers to remove it. This benefits emergency users, disabled users and other users who need to remove the cap in a hurry.
4) Since the upper surface of the faceplate lies on top of the tieplate, there is no break line nor juncture to interrupt decor or gather dust.
5) The entire assembly consists of one slide-on groove and mating flange, minimizing moving parts with the effect of greatly improving life of the assembly.
6) The simple groove and mating flange requires just a single draw to inject mould the faceplate.
7) No training is necessary to remove this cover, nor labels.

For these reasons, the Invention in this Application is significantly different from Prior Art, and is a boon to the interior director looking for a way to diminish the necessary but unsightly visual interruption formed by the plug and receptacle.

### DETAILED DESCRIPTION OF THE INVENTION

Electrical outlets consist of an electrical box mounted into the wall, fitted with a number of electrical receptacles hooked up to the electrical supply. This plate is covered for safety reasons by a tieplate tied into the box by means of one or more fasteners, usually machine screws. Plugs are plugged directly into the receptacle. Safety hazards with children poking fingers and objects into the live holes are tolerated hazards; the Invention offers a convenient and partial solution removing the electrical receptacles from view. The main focus of this invention is, however, the aesthetic benefit of using faceplates that slide down over the tieplate by means of an internal, rear groove on the faceplate mating with an offset flange on the tieplate. This allows electrical cords to hang freely down through the bottom hole of the faceplate. Essential to this invention is the use of flat-headed plugs that redirect the wire vector from the horizontal to the vertical down, or optionally offset from the downward vertical by some angle.

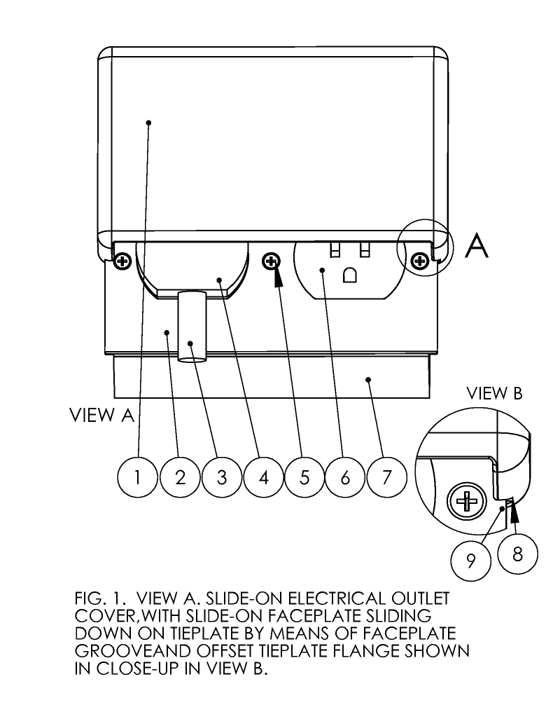

Reference to View A of FIG. 1 will give a better understanding of this Invention. A slide-on faceplate (1) in a rectangular prismatic form with bottom open slides over a protective tieplate (2) tied with one or more fasteners (5) to a mounted electrical box (7) allowing for insertion of flat-headed electrical plug(s) (4) into the electrical receptacle (5), in turn letting the electrical cable (3) emanating from the plug hang down or offset from the downward vertical by an angle of 45 degrees of less. Reference to View B of FIG. 1 will show the groove (8) offset from the mounting plane of the electrical box to allow slide over and down of the faceplate equipped with a rear internal groove (9).

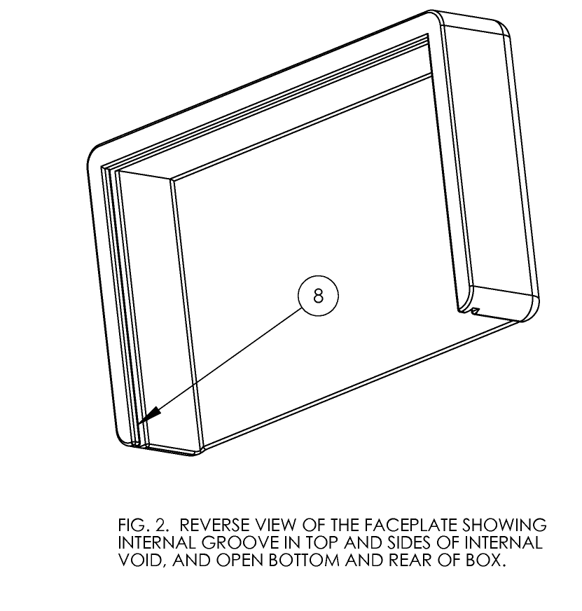

The nature of the groove in the reverse internal side of the faceplate box can be more clearly viewed in FIG. 2 (8). It can be seen that the groove is to the top and sides, but that the bottom of the box is open to allow for the slide onto the tieplate.

The Invention will vary in form depending on whether the electrical outlet is vertical or horizontal, how many fasteners are used to tie the tieplate to the electrical outlet, and even in the introduction of slight opening to the lower portion of either side of the faceplate to accommodate plugs that have a cable emanating from the plug bottom at an angle to the downward vertical.

Since the entire faceplate box except for the bottom is free from fasteners, electrical receptacle holes, and other visual distractions, leaving the faceplate free to bear a variety of finishes, including in-mould decorating, conventional plating, mirror finish, texture, and three-dimensional ornament.

1) In this Invention, an internally-grooved faceplate slides over and down a flanged frontal tieplate screwed onto an electrical outlet to cover the open holes and screw heads of the electrical outlet yet not disturb flat-headed electrical cords plugged into the outlet by virtue of the open bottom of the faceplate.

2) This Invention requires no fasteners to attach the faceplate to the tieplate.

3) The faceplate can bear a variety of finishes, including in-mould decorating, conventional plating, mirror finish, texture, and three-dimensional ornament.
